(19) United States
(12) Patent Application Publication
(10) Pub. No.: US 2008/0163750 A1
(43) Pub. Date: Jul. 10, 2008

(54) System and method for controlling actuator position

(75) Inventors: Qinghui Yuan, Maple Grove, MN (US); Christy W. Schottler, Brooklyn Park, MN (US); Jae Y. Lew, Shorewood, MN (US)

Correspondence Address: EATON CORPORATION;EATON CENTER, 1111 SUPERIOR AVENUE, CLEVELAND, OH, 44114, US

(73) Assignees: QINGHUI YUAN; CHRISTY W. SCHOTTLER; JAE Y. LEW

(21) Appl. No.: 11/650,267

(22) Filed: Jan. 5, 2007

(51) Int. Cl. F15B 15/28; F15B 13/16; G05D 7/06

(52) U.S. Cl. 91/402; 91/392; 701/50; 700/282

(57) ABSTRACT

An method for estimating actuator position includes the steps of receiving fluid pressure data signals from a plurality of fluid pressure sensors (31), receiving spool position signals from at least one spool position sensor (33), and receiving actuator position data signals from at least one actuator position sensor (35). Corrected flow rates to and from an actuator (21) are determined with each corrected flow rate being based on fluid pressure data signals, the spool position signals, and an error-correction factor, wherein the error-correction factor is a function of the fluid pressure data signals and the spool position signals. An estimated actuator position is determined wherein the estimated position includes a kinematic component and a dynamic component. Adaptive gain factors are applied to calibrate the estimated actuator position to the actuator position data signals from the actuator position sensor.

### BACKGROUND

1. Field of the Invention

The present invention relates to a system and method for controlling actuator position, and more particularly to an adaptive system and method that includes error correction.

2. Description of the Related Art

Fluid actuators are used in various hydraulic applications, including skid steer loaders, boom lifts, and mini excavators. The fluid actuators in these applications typically have a piston, which is encased by a cylinder, and a rod, which is attached to some accessory such as a bucket or a boom. In adjusting the position of the actuator, typically an operator of the application must manually actuate a joystick, which controls the position of the fluid actuator, and approximate the position of the actuator based on sight. If the operator's approximation is not correct, the operator must make minor adjustments to the position of the cylinder through the joystick. In some situations, the accurate positioning of the actuator could be critical, such as when positioning an actuator near electrical lines or near gas lines or water mains.

Some manufacturers have recommended using position sensors on the actuators. These position sensors typically require some type of marking on the rod so that the sensor can accurately sense the position of the actuator. While this would likely work in most applications, the sensors and the required markings on the rod significantly affect the cost of the actuator. As a result, most of the fluid actuators on these types of hydraulic applications do not use position sensors.

Information relevant to attempts to address the cost prohibitiveness of position sensing can be found in U.S. Pat. Nos. 6,848,323 and 7,114,430. However, each one of these references suffers from the disadvantage of not being precise enough to provide an accurate location of the actuator.

### BRIEF SUMMARY

An actuator position control system comprises an actuator and at least one actuator position sensor mounted to the actuator. The actuator position control system further includes a flow control valve, which is in fluid communication with the actuator, that has at least one main stage spool, at least one spool position sensor, a supply port, a tank port, a first control port, and a second control port. A plurality of pressure sensors are included to monitor pressure of fluid at the supply port, the tank port, the first control port, and the second control port of the flow control valve. A controller is in electrical communication with the flow control valve wherein the controller is configured to receive a desired actuator position input, fluid pressure data signals from the plurality of fluid pressure sensors, spool position signals from the spool position sensor, and actuator position data signals from the actuator position sensor. The controller is further configured to determine the corrected fluid flow rates to and from the actuator based on the fluid pressure data signals, the spool position signals, and an error-correction factor, wherein the error-correction factor is a function of fluid pressure data signals and the spool position signals. The controller than calculates an estimated actuator position, wherein the estimated actuator position calculation includes a kinematic component, which is a function of the corrected fluid flow rates to and from the actuator, and a dynamic component, which is a function of pressure in a chamber of the actuator. Adaptive gain factors are applied to calibrate the estimated actuator position to the actuator position data signals from the actuator position sensor. The controller makes a comparison between the estimated actuator position and the desired actuator position input and then closes the main stage spool valve to prevent fluid communication to the actuator.

A method for estimating actuator position comprises the steps of receiving fluid pressure data signals from the plurality of fluid pressure sensors, spool position signals from the spool position sensor, and actuator position data signals from the actuator position sensor. Corrected fluid flow rates to and from an actuator are determined based on the fluid pressure data signals, the spool position signals, and an error-correction factor, wherein the error-correction factor is a function of the fluid pressure data signals and the spool position signals. The estimated actuator position is calculated, wherein the estimated actuator position calculation includes a kinematic component, which is a function of the corrected fluid flow rates to and from the actuator, and a dynamic component, which is a function of pressure of a chamber of the actuator. Adaptive gain factors are applied to calibrate the estimated actuator position to the actuator position data signals from the actuator position sensor.

### BRIEF DESCRIPTION OF THE DRAWINGS

The accompanying drawings are included to provide a further understanding of the present invention and are incorporated in and constitute part of this specification. The drawings illustrate exemplary embodiments of the present invention and together with the description serve to further explain the principles of the invention, wherein:

FIG. 1 is a schematic of an actuator position control system, which is made in accordance with the present invention.

FIG. 2a is a schematic of a flow control valve in a first position, which is made in accordance with the present invention.

FIG. 2b is a schematic of a flow control valve in a second position, which is made in accordance with the present invention.

FIG. 3 is a block diagram of a method for controlling actuator position in accordance with the present invention.

FIG. 4 is a block diagram of a method for estimating the position of an actuator in accordance with the present invention

FIG. 5 is a plot of actuator position versus time.

FIG. 6 is a block diagram of an alternate method for estimating the position of an actuator in accordance with the present invention.

FIG. 7 is a block diagram of an alternate method for estimating the position of an actuator in accordance with the present invention.

### DETAILED DESCRIPTION

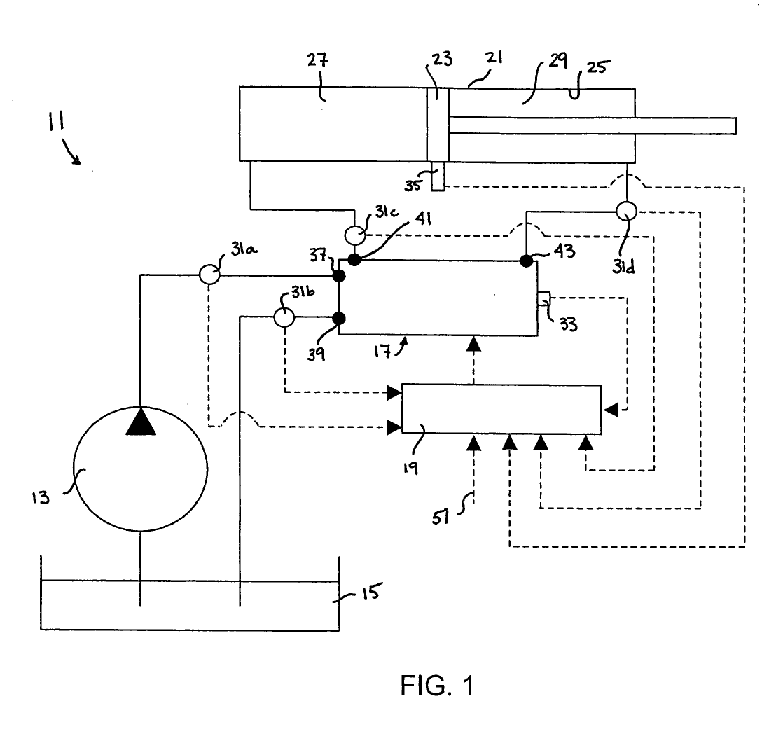

Referring now to the drawings, which are not intended to limit the invention, FIG. 1 illustrates a schematic representation of an actuator position control system, generally designated 11. The actuator position control system 11 includes a fluid pump 13, shown herein as a fixed displacement pump, a system reservoir 15, a flow control valve, generally designated 17, a controller 19, and a linear actuator, or cylinder, 21. The cylinder 21 includes a piston 23, which separates an internal bore 25 of the cylinder 21 into a first chamber 27 and a second chamber 29. While the actuator position control system 11 is described with regard to the cylinder 21, it will be understood by those skilled in the art after reviewing the disclosure of the present invention that the scope of the present invention is not limited to linear actuators. The actuator position control system 11 and the methods described herein could also be used to determine the position of a rotary actuator. Therefore, the term “actuator” as used in the appended claims shall refer to both rotary and linear actuators.

The actuator position control system 11 also includes a plurality of fluid pressure sensors 31a, 31b, 31c, 31d that monitor the pressure of the fluid associated with the fluid pump 13, the system reservoir 15, the first chamber 27 of the cylinder 21, and the second chamber 29 of the cylinder 21, respectively. The actuator position control system 11 also includes at least one spool position sensor 33, which will be described in more detail subsequently, and at least one actuator position sensor 35. While the actuator position sensor 35 is shown in a center location of the cylinder 21, it will be understood by those skilled in the art after reviewing the disclosure of the present invention that the location of the actuator position sensor 35 could be anywhere along the cylinder 21. In addition, it will be understood by those skilled in the art after reviewing the disclosure of the present invention that multiple actuator position sensors 35 could be used in the actuator position control system 11. However, increasing the number of actuator position sensors 35 would likely increase the cost of the actuator position control system 11. In the subject embodiment, the actuator position sensor 35 is of a latch sensor type, which transmits a signal to the controller 19 when the piston 23 of the cylinder 21 is sensed by the actuator position sensor 35. However, as there are various types of actuator position sensors 35 that would be adequate, the scope of the present invention is not limited to actuator position sensors 35 of the latch sensor type. Data from these sensors 31, 33, 35 is transmitted to the controller 19.

Referring still to FIG. 1, the flow control valve 17 will now be described. In the subject embodiment, the flow control valve 17 includes a plurality of ports including a supply port 37, which is in fluid communication with the fluid pump 13 and the pressure sensor 31a, a tank port 39, which is in fluid communication with the system reservoir 15 and the pressure sensor 31b, a first control port 41, which is in fluid communication with the first chamber 27 of the cylinder 21 and the pressure sensor 31c, and a second control port 43, which is in fluid communication with the second chamber 29 of the cylinder 21 and the pressure sensor 31d. In the subject embodiment, when the flow control valve 17 allows fluid communication between the supply port 37 and the first control port 41 and between the tank port 39 and the second control port 43, pressurized fluid from the fluid pump 13 flows through the flow control valve 17 into the first chamber 27 of the cylinder 21, while fluid from the second chamber 29 flows to the system reservoir 15. This fluid communication results in the extension of the cylinder 21. In the alternative, when the flow control valve 17 allows fluid communication between the tank port 39 and the first control port 41, and between the supply port 37 and the second control port 43, pressurized fluid from the fluid pump 13 flows through the flow control valve 17 into the second chamber 29 of the cylinder 21, while fluid from the first chamber 27 flows to the system reservoir 15. This fluid communication results in the retraction of the cylinder 21.

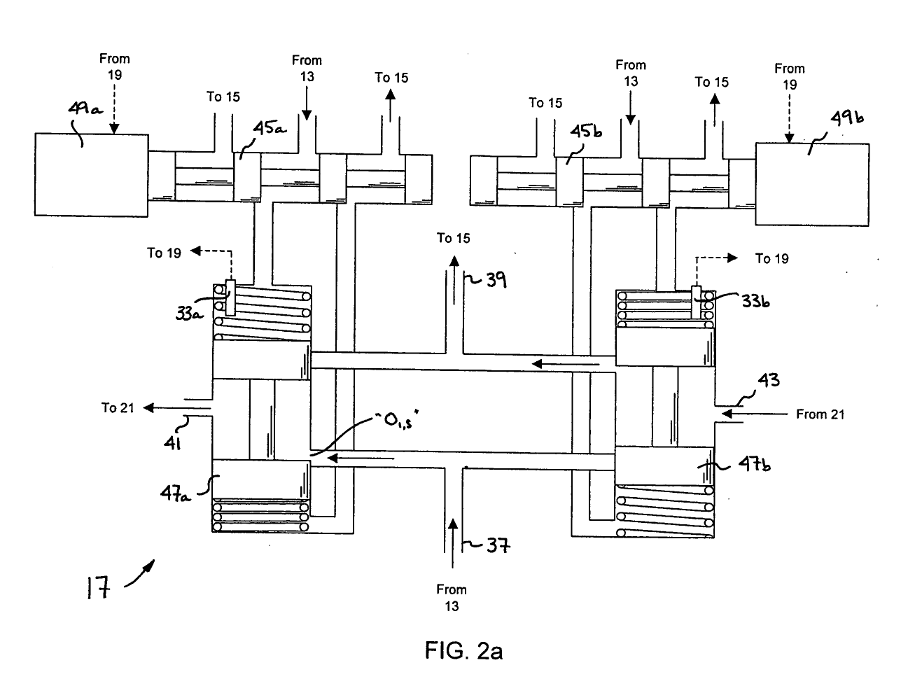

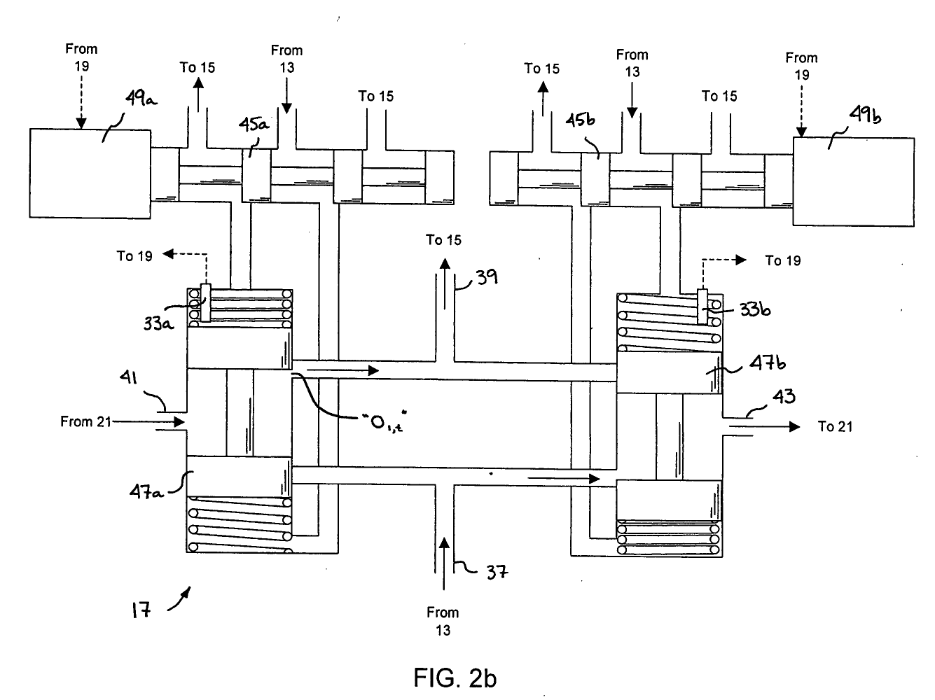

FIGS. 2a and 2b provide schematic representations of an exemplary embodiment of the flow control valve 17. In addition to the plurality of ports 37, 39, 41, 43 described above, the flow control valve 17 further includes two pilot stage spools 45a, 45b and two main stage spools 47a, 47b associated with the cylinder 21. It shall be understood by those skilled in the art, however, after reviewing the disclosure of the present invention that while the subject embodiment has shown the flow control valve 17 schematically in FIGS. 2a and 2b as having two pilot stage spools 45a, 45b and two main stage spools 47a, 47b in association with a single cylinder 21, it is also within the scope of the present invention to have only one pilot stage spool 45 and one main stage spool 47 in association with a single cylinder 21, or any combination thereof.

The positions of the pilot stage spools 45a, 45b are controlled by actuators 49a, 49b, respectively. While it is preferred that actuators 49a, 49b are of the electromagnetic type, such as voice coils, it will be understood by those skilled in the art after reviewing the disclosure of the present invention that actuators 49a, 49b could be of any type that is capable of providing linear motion to the pilot stage spools 45a, 45b. The positions of the pilot stage spools 45a, 45b control the positions of the main stage spools 47a, 47b, respectively, by regulating the fluid pressure that acts on either end of the main stage spools 47a, 47b. The positions of the main stage spools 47a, 47b, on the other hand, control the fluid flow rate to the cylinder 21. In the subject embodiment, the spool position sensors 33a, 33b measures the positions of the main stage spools 47a, 47b, respectively, and transmit position data to the controller 19 for use by the controller 19 in determining an estimated actuator position, which will be described in greater detail subsequently. While many different types of spool position sensors 33a, 33b would be adequate for use in this system, Linear Variable Differential Transformers (LVDTs) are preferred. In FIG. 2a, the flow control valve 17 is in a first position in which the actuator 49a positions the pilot stage spool 45a such that the main stage spool 47a provides fluid communication between the supply port 37 and the first control port 41, while the actuator 49b positions the pilot stage spool 45b such that the main stage spool 47b provides fluid communication between the tank port 39 and the second control port 43. In the subject embodiment, this first position would result in the extension of the cylinder 21. In FIG. 2b, the flow control valve 17 is in a second position in which the actuator 49a positions the pilot stage spool 45a such that the main stage spool 47a provides fluid communication between the tank port 39 and the first control port 41, while the actuator 49b positions the pilot stage spool 45b such that the main stage spool 47b provides fluid communication between the supply port 37 and the second control port 43. In the subject embodiment, this second position would result in the retraction of the cylinder 21.

Referring again to FIG. 1, the pressure sensors 31 are shown external to the flow control valve 17. However, the scope of the present invention is not limited to the pressure sensors 31 being external to the flow control valve 17. In the preferred embodiment, the pressure sensors 31 would be integrated in the flow control valve 17. Such an arrangement is described in UK Pat. No. GB2328524 and is incorporated herein by reference. In addition, the controller 19 is also shown schematically in FIG. 1 as being external to the flow control valve 17. However, the scope of the present invention is not limited to the controller 19 being external to the flow control valve 17. In the preferred embodiment, the controller 19 would also be integrated in the flow control valve 17.

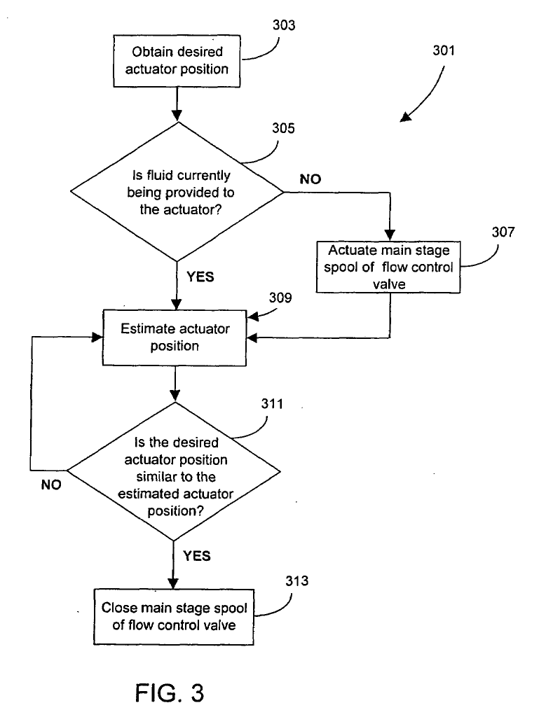

Referring now primarily to FIG. 3 with references made to elements introduced in FIGS. 1 and 2, a method 301 for controlling an actuator will be described. In step 303 of the method 301, a desired actuator position 51 (shown schematically in FIG. 1) is obtained by the controller 19. The desired actuator position can be inputted in a variety of ways, including but not limited to a joystick used by an operator or through a keyboard. In step 305, the controller 19 determines whether fluid is currently being provided to the cylinder 21. This determination can be made by the controller from information received from the spool position sensors 33a, 33b. If there is no fluid being provided to the cylinder 21, the controller 19 sends a signal to the actuators 49a, 49b to actuate the pilot stage spools 45a, 45b, which in turn actuate the main stage spools 47a, 47b, in step 307. This allows for fluid communication to and from the appropriate chambers 27, 29 of the cylinder 21. If fluid is currently being communicated to and from the appropriate chambers 27, 29 of the cylinder 21, the method 301 proceeds to the next step. An estimated actuator position is then determined using a method 309 that will be described in greater detail subsequently. In step 311, a comparison is made between the desired actuator position and the estimated actuator position determined by the method 309. If these actuator positions are similar, a signal is communicated to the actuators 49a, 49b that results in the closing of the main stage spool valves 47a, 47b, which prevents further fluid communication to the cylinder 21. It will be understood by those skilled in the art after reviewing the disclosure of the present invention that the step 311 could also include the step of communicating a signal to the actuators 49a, 49b to begin closing the main stage spool valves 47a, 47b as the desired actuator position and the estimated actuator position get closer in value. This step would avoid an abrupt stop in the movement of the cylinder 21. If, however, the estimated actuator position and the desired position are not similar, the main stage spool valves 47a, 47b are left in position and the actuator position is again estimated using method 309.

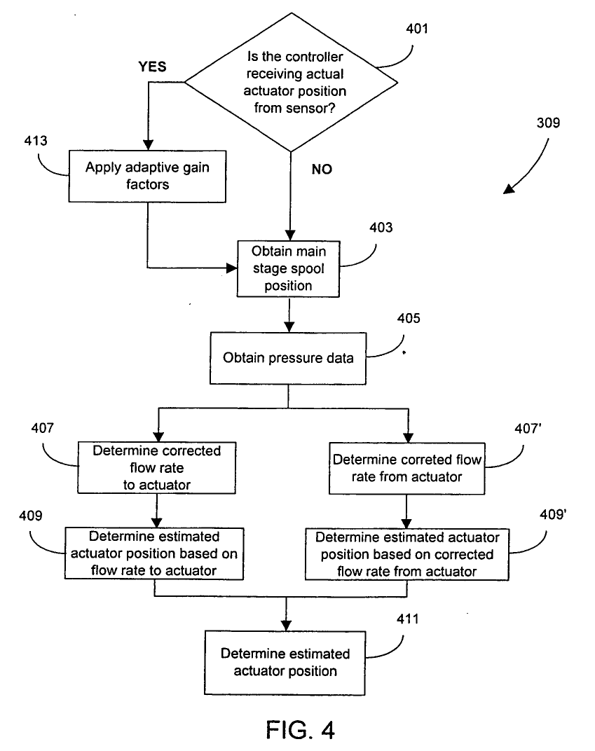

Referring now to FIG. 4, the method 309, which estimates actuator position, will now be described in greater detail. In step 401, a determination is made as to whether the controller 19 is receiving actual actuator position data from the actuator position sensor 35. If no actual actuator position data has been received, a position, X_{Sp1}, of the main stage spool 47a, which is associated with the first chamber 27 of the cylinder 21 and a position, X_{Sp2}, of the main stage spool 47b, which is associated with the second chamber 29 of the cylinder 21, is obtained in step 403 from the spool position sensors 33a, 33b. In step 405, fluid pressure data corresponding to the pressure of the fluid at the fluid pump 13, referred to hereinafter as P_{S}, the system reservoir 15, referred to hereinafter as Pₜ, the first chamber 27 of the cylinder 21, referred to hereinafter as P₁, and the second chamber 29 of the cylinder 21, referred to hereinafter as P₂, is obtained from the fluid pressure sensors 31a, 31b, 31c, 31d. It will be understood by those skilled in the art that the order of steps 401, 403, and 405 are not critical to the scope of the present invention.

In steps 407 and 407′, corrected flow rates, Q_{1,C} and Q_{2,C}, are calculated with regard to fluid flowing to and from the cylinder 21. The corrected flow rate is a flow rate calculation that reduces or “corrects” implicit errors in a theoretical flow rate equation by multiplying the theoretical flow rate by an error-correction factor. For ease of description, this calculation will be described with regard to the first chamber 27 of the cylinder 21 only. It will be understood by those skilled in the art after reviewing the disclosure of the present invention, however, that the calculation of the corrected flow rate, Q_{2,C}, associated with the second chamber 29 of the cylinder 21 is similar to the calculation of the corrected flow rate, Q_{1,C}, which is described below. The corrected flow rate equation, Q_{1,C}, associated with the first chamber 27 of the cylinder 21 is:

Q_{1,C}=K₁·Q₁,

where Q₁ is the estimated flow rate of fluid to or from the first chamber 27 of the cylinder 21, and K₁ is the error-correction factor. A more detailed description of these terms is provided immediately below.

The estimated flow rate, Q₁, is a theoretical nonlinear function based on variables P_{S}, Pₜ, P₁, and X_{Sp1}. While there are a variety of equations that could be used to calculate the estimated flow rate, Q₁, two exemplary equations are provided below. The first equation would be used if the main stage spool 47a of the flow control valve 17 was positioned such that the first control port 41 was in fluid communication with the supply port 37. In other words, the following equation would be used when fluid is flowing from the fluid pump 13 to the first chamber 27 of the cylinder 21, thereby resulting in the extension of cylinder 21. It should be noted, however, that the following equation would also be used when the pressure of the fluid in the first chamber 27 is greater than the pressure of the fluid being output from the fluid pump 13, even though this situation would create a backflow of fluid from the first chamber 27 to the fluid pump 13 which would result in the retraction of the cylinder 21. In both of these scenarios, Q₁ may be calculated using the following equation:

$${Q}_{1} = {C}_{d} \cdot W \cdot {X}_{Sp 1} \cdot sgn ( {P}_{S} - {P}_{1} ) \cdot \sqrt{\frac{2 \cdot \vert {P}_{S} - {P}_{1} \vert}{ρ}} ,$$

where C_{d} is a discharge coefficient, X_{Sp1} is the position of the main stage spool 47a, W is a differential of orifice area, which is a function of the main stage spool position, over a differential of the main stage spool position, dA(Xₛₚ₁)/dXₛₚ₁, (the orifice is shown in FIG. 2a by reference letter “O_{1,S}”), and ρ is the density of the fluid.

The second equation would be used if the main stage spool 47a of the flow control valve 17 was positioned such that the first control port 41 was in fluid communication with the tank port 31. In other words, the following equation would be used when fluid is flowing from the first chamber 27 of the cylinder 21 to the system reservoir 15, thereby resulting in the retraction of the cylinder 21. In this scenario, Q₁ may be calculated using the following equation:

$${Q}_{1} = {C}_{d} \cdot W \cdot {X}_{Sp 1} \cdot sgn ( {P}_{1} - {P}_{t} ) \cdot \sqrt{\frac{2 \cdot \vert {P}_{1} - {P}_{t} \vert}{ρ}} ,$$

where C_{d} is a discharge coefficient, X_{Sp1} is the position of the main stage spool 47a, W is a differential of orifice area, which is a function of the main stage spool position, over a differential of the main stage spool position, dA(X_{Sp1})/dX_{Sp1}, (the orifice is shown in FIG. 2b by reference letter “O_{1,t}”), and ρ is the density of the fluid.

As stated above, the estimated flow rate, Q₁, is a theoretical equation. Due to multiple factors, including but not limited to fluid viscosity, fluid type, fluid temperature, etc., the estimated flow rate, Q₁, does not always correlate to a flow rate that is experimentally measured. Therefore, an error-correction factor, K₁, is used to reduce error associated with the theoretical equation. The error-correction factor, K₁, is defined by the following nonlinear function: K₁=ƒ(Pₛ, P₁, Pₜ, X_{Sp1}). As this function may be determined experimentally, a variety of equations could be used to correlate the independent variables to the correction factor. An example of such an equation is provided below:

$${K}_{1} = {c}_{0} + {c}_{1} \cdot {X}_{Sp 1} + {c}_{2} \cdot \sqrt{{P}_{S} - {P}_{1}} + {c}_{3} \cdot {X}_{Sp 1}^{2} + {c}_{4} \cdot ( {P}_{S} - {P}_{1} ) ,$$

where c₀, c₁, c₃, and c₄ are experimentally determined coefficients.

It will be understood by those skilled in the art after reviewing the disclosure of the present invention that the scope of the present invention does not require that these calculations be performed during the operation of the actuator position control system 11. Rather, the values of the corrected flow rates, Q_{1,C} and Q_{2,C}, could be contained in a look-up table, which are retrievable based on the values of input parameters P_{S}, Pₜ, P₁, P₂, X_{Sp1} and X_{Sp2}.

In steps 409 and 409′, estimated actuator positions, X_{1,Est} and X_{2,ESt}, of the cylinder 21 are determined based on the corrected flow rates, Q_{1,C} and Q_{2,C}, respectively. For ease of description, this determination will be described with regard to the corrected flow rate, Q_{1,C}, of the first chamber 27 of the cylinder 21 only. It will be understood by those skilled in the art after reviewing the disclosure of the present invention, however, that the determination of the estimated actuator position, X_{2,ESt}, with regard to the corrected flow rate, Q_{2,C}, of the second chamber 29 of the cylinder 21 is similar. In the subject embodiment, the position of the cylinder 21 with regard to the corrected flow rate, Q_{1,C}, of the first chamber 27 is calculated by integrating an equation for the velocity of the piston 23, X*_{1,Est}, over a period of time, where the equation for the velocity of the piston 23, X*_{1,Est}, has a dynamic component and a kinematic component. An example of such an equation is provided below:

$${X}_{1 , Est}^{*} = [ \frac{1}{{β}_{Est} A} ( - A {η}_{1} {X}_{1 , Est} - {η}_{1} {V}_{1} ) ] + [ \frac{1}{A} {Q}_{1 , C} ] ,$$

where β_{Est} is the estimated bulk modulus of the fluid; A is the area of the piston 23 that is subjected to pressurized fluid; V₁ is the volume of the first chamber 27 of the cylinder 21 when the piston 23 is fully retracted; X_{1,Est} is the estimated actuator position; η₁ represents the variation in fluid pressure, P₁, in the first chamber 27 of the cylinder 21 over a given sample time that has been filtered to eliminate noise; and Q_{1,C} is the corrected flow rate. The dynamic component of the above velocity equation is provided in the first set of square brackets and in the above equation is a function of the fluid pressure, P₁, in the first chamber 27 of the cylinder 21. The kinematic component of the above velocity equation is provide in the second set of square brackets and is based on the corrected flow rate, Q_{1,C}, divided by the area of the piston 23 that is subjected to pressurized fluid.

In step 411, the estimated positions, X_{1,Est} and X_{2,ESt}, of the cylinder 21 are compared. If those positions are different from each other, a determination of the estimated actuator position, X_{Est}, is made. This determination could be made by taking the arithmetic mean of the positions, X_{1,Est}, and X_{2,Est}, or by using some other weighted average function.

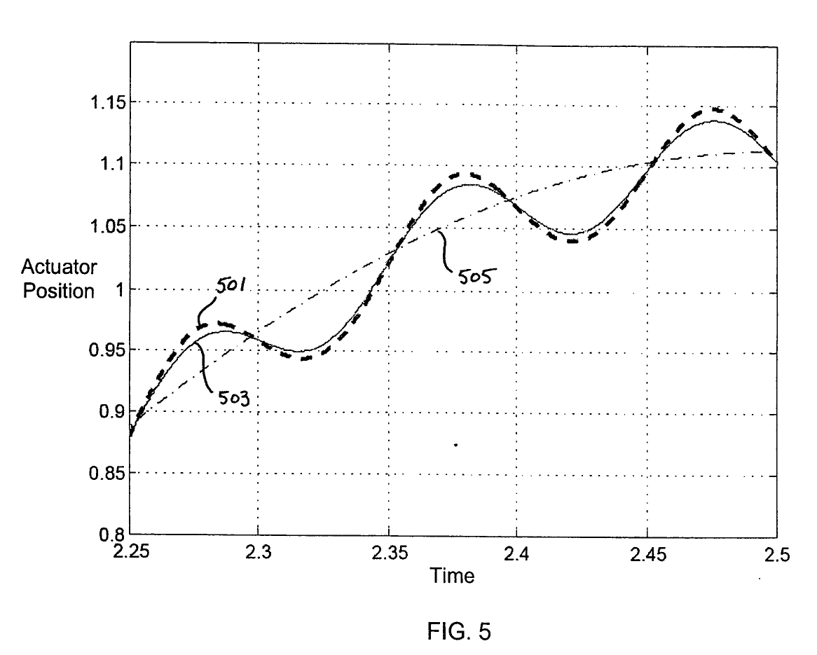

Referring now to FIG. 5, the importance of including both the dynamic and kinematic components in the determination of the estimated actuator positions, X_{1,Est}, and X_{2,Est}, is shown. Plots of actual actuator position 501, estimated actuator position 503, and kinematic actuator position 505, which is based solely on the kinematic component of the velocity equation, are provided in FIG. 5. In this plot, the piston 23 of the cylinder 21 is oscillating while expanding. The oscillation could be caused an external condition, such as an outside force exerted against the cylinder 21. The kinematic actuator position 505 is only able to capture the overall movement of the piston 23 and therefore does not capture the oscillations of the piston 23. In the subject embodiment, and by way of example only, this results in the kinematic actuator position having an error of around 5%, although this error could be much larger depending on the outside force acting against the cylinder 21. The estimated actuator position 503, which includes the dynamic component and the kinematic component described above, on the other hand, closely approximates the actual actuator position 501, including the oscillations of the piston 23 due to the outside force acting against the cylinder 21.

Referring again to FIG. 4, the adaptivity of the method 309, which estimates the actuator position, will now be described. If the controller 19 has received the actual actuator position, X_{Act}, from the actuator position sensor 35 in step 401 and the estimated actuator positions, X_{1,Est}, and X_{2,Est}, with respect to the first 27 and the second 29 chambers of the cylinder 21, respectively, are different than the actual actuator position, X_{Act}, adaptive gain factors, δ₁ and δ₂ are determined in step 413 to calibrate the estimated actuator positions to the actual actuator position. Thus, the adaptive gain factors, δ₁ and δ₂, are based on the actuator position errors, X_{1,Err} and X_{2,Err}, respectively, where X_{1,Err}=X_{1,EST}−X_{Act} and X_{2,Err}=X_{2,Est}−X_{Act}. The adaptive gain factors, δ₁ and δ₂, are then applied as an adjustment to the determination of the corrected flow rates, Q_{1,C} and Q_{2,C}. This adjustment to the corrected flow rates, Q_{1,C} and Q_{2,C}, can be accomplished by multiplying the error-correction factors, K₁ and K₂, by the adaptive gain factors, δ₁ and δ₂, respectively.

A theoretical equation that represents the actuator position error, X_{1,Err}, will be briefly described in order to demonstrate how that adjustment to the error-correction flow rates are made. While only the actuator position error, X_{1,Err}, with respect to the first chamber 27 of the cylinder 21 will be described, it will be understood by those skilled in the art after reviewing the disclosure of the present invention that the adjustment based on the actuator position error, X_{2,Err}, with respect to the second chamber 29 of the cylinder 21 is similar. The theoretical equation for the actuator position error, X_{1,Err}, is given below:

$${X}_{1 , Err} ( t + 1 ) = [ {\int }^{t + 1} ( \frac{- {η}_{1}}{{β}_{Est}} {X}_{1 , Err} + \frac{1}{{β}_{Err}} ( - {η}_{1} {X}_{1 , Est} - {η}_{1} {V}_{1} \frac{1}{A} ) ) d t ] + [ {\int }^{t + 1} - \frac{1}{A} {Q}_{1 , Err} d t ] ,$$

where X_{1,Err}(t+1) is the actuator position error at sample time t+1, β_{Est} is the estimated bulk modulus of the fluid; β_{Err} is the error associated with the bulk modulus of the fluid which may be calculated using the following equation:

$$\frac{1}{{β}_{Err}} = \frac{1}{{β}_{Est}} - \frac{1}{{β}_{Act}} ;$$

A is the area of the piston 23 that is subjected to pressurized fluid; V₁ is the volume of the first chamber 27 of the cylinder 21 when the piston 23 is fully retracted; X_{1,Est} is an estimate of the actuator position; η₁ represents the variation in fluid pressure, P₁, in the first chamber 27 of the cylinder 21 over a given sample time that has been filtered to eliminate noise; and Q_{1,Err} is the flow rate error which is calculated using the following equation: Q_{1,C}−Q_{1,ACT}, where Q_{1,ACT} is the actual flow rate to the first chamber 27.

It should be noted that all of the terms in the integral in the first set of square brackets in the theoretical equation for the actuator position error are multiplied by η₁, which represents the filtered variation in fluid pressure in the first chamber 27 of the cylinder 21. This term η₁ could be positive or negative depending on the fluid pressure variations in the first chamber 27 over a given sample time. As these fluid pressure variations are largely the result of external conditions, such as an outside force exerted against the cylinder 21, η₁ is a term that is somewhat unpredictable. As a result of this unpredictability, it would be difficult to correlate an adjustment to one of the terms in the integral in the first set of square brackets with the actuator position error, X_{1,Err}, with respect to the first chamber 27. However, an adjustment to one of the terms in the integral in the second set of brackets in the above equation could be more readily correlated to the actuator position error, X_{1,Err}, due to the predictability of those terms. An example will be briefly explained to demonstrate how the error-correction factor, K₁, could be correlated to the actuator position error, X_{1,Err}. The integral in the second set of brackets can be simplified as:

$${\int }^{t + 1} \frac{{Q}_{1 , ACT} - {K}_{1} \cdot {Q}_{1}}{A} d t .$$

Therefore, assuming that the actuator position error, X_{1,Err}, is governed by this integral, if the difference between the estimated actuator position, X_{1,Est}, and the actual actuator position, X_{Act}, is positive, the error-correction factor, K₁, should be increased. On the other hand, if the difference between the estimated actuator position, X_{1,Est}, and the actual actuator position, X_{Act}, is negative, the error-correction factor, K₁, should be decreased. Thus, if the main stage spool 47a of the flow control valve 17 is positioned such that the first control port 41 is in fluid communication with the supply port 37 and the actuator position error, X_{1,Err}, is greater than zero, then the correction factor, K₁, is multiplied by an adaptive gain factor, δ₁, where δ₁>1. In this example, the equation for the corrected flow rate, Q_{1,c}, would be Q_{1,c}=δ₁·K₁·Q₁. If the main stage spool 47a of the flow control valve 17 is positioned such that the first control port 41 is in fluid communication with the supply port 37 but the actuator position error is less than or equal to zero, then the error-correction factor, K₁, is

multiplied by an adaptive gain factor

$$\frac{1}{{δ}_{1}} ,$$

where δ₁>1. In this example, the equation for the corrected flow rate, Q_{1,c}, would be

$${Q}_{I , c} = \frac{1}{{δ}_{1}} \cdot {K}_{I} \cdot {Q}_{I} .$$

If, however, the main stage spool 47a of the flow control valve 17 is positioned such that the first control port 41 is in fluid communication with the tank port 39 and the actuator position error, X_{1,Err}, is greater than zero, then the correction factor, K₁, is multiplied by an adaptive gain factor,

$$\frac{1}{{δ}_{1}} ,$$

where δ₁>1. In this example, the equation for the corrected flow rate, Q_{1,c}, would be

$${Q}_{I , c} = \frac{1}{{δ}_{1}} \cdot {K}_{I} \cdot {Q}_{I} .$$

If the main stage spool 47a of the flow control valve 17 is positioned such that the first control port 41 is in fluid communication with the tank port 39 but the actuator position error, X_{1,Err}, is less than or equal to zero, then the error-correction factor, K₁, is multiplied by an adaptive gain factor δ₁, where δ₁>1. In this example, the equation for the corrected flow rate, Q_{1,c}, would be Q_{1,c}=δ₁·K₁·Q₁.

In the preferred embodiment of the present invention, the adaptive gain factor, δ₁, is a function of the actual position error, X_{1,Err}. The larger the actuator position error, the more aggressive the change to the error-correction factor, K₁, will be. However, it will be understood by those skilled in the art after reviewing the disclosure of the present invention that the adaptive gain factor, δ₁, could be any real value. In order to prevent an overly aggressive change to the error-correction factor, K₁, in the preferred embodiment, the adaptive gain factor, δ, would be less than or equal to two.

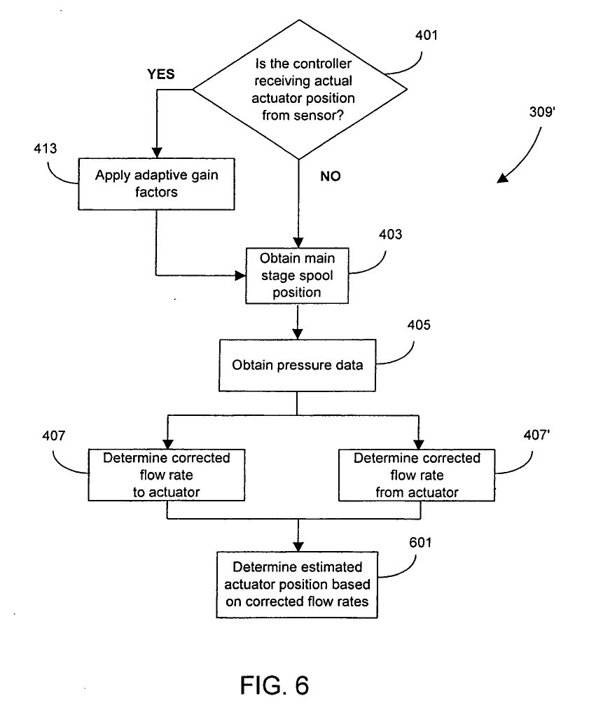

Referring now to FIG. 6, an alternate method 309′ used by the controller to determine the estimated position of the cylinder 21 will be described. In this alternative method 309′, method steps that are the same or similar as those in the method 309 will have the same reference number and will not be further described. Additional method steps, however, shall have reference numerals in excess of “600” and shall be described in detail.

Similar to the method 309, in step 401 of the alternative method 309′, a determination is made as to whether the controller 19 is receiving actual actuator position data from the actuator position sensor 35. If no actual actuator position data has been received, positions, X_{Sp1} and X_{Sp2}, of the main stage spools 47a, 47b which are associated with the first and second chambers 27, 29, respectively, of the cylinder 21, are obtained in step 403 from the spool position sensors 33a, 33b. In step 405, fluid pressure data P_{S}, Pₜ, P₁, and P₂ is obtained from the fluid pressure sensors 31a, 31b, 31c, 31d, respectively. It will be understood by those skilled in the art that the order of steps 401, 403, and 405 are not critical to the scope of the present invention.

In steps 407 and 407′, corrected flow rates, Q_{1,C} and Q_{2,C}, are determined with regard to fluid flowing to and from the cylinder 21, where the corrected flow rate determinations would be similar to those described in method 309. In step 601, a corrected flow rate, Q_{C}, is determined based on the corrected flow rates, Q_{1,C} and Q_{2,C}. If the corrected flow rates, Q_{1,C} and Q_{2,C}, are equal, then the corrected flow rate, Q_{c}, could equal Q_{1,C} and Q_{2,C}. If, however, the corrected flow rates, Q_{1,C} and Q_{2,C}, are different from each other, a determination of the corrected flow rate, Q_{C}, is made. This determination could be made by taking the arithmetic mean of the corrected flow rates, Q_{1,C} and Q_{2,C}, or by using some other weighted average function. Following this determination, the estimated actuator position, X_{Est}, is calculated based on the corrected flow rate, Q_{C}, in a calculation that is similar to that described with regard to method 309. The adaptivity of the method 309′ in step 413 is similar to that described in step 413 in method 309.

An advantage to using the methods 309 and 309′ to determine actuator position is that the methods 309 and 309′ incorporate three ways in which errors associated with the theoretical calculations are minimized. The first way involves the use of the error-correction factors, K₁ and K₂. These error-correction factors, K₁ and K₂, minimize errors associated with the calculation of the theoretical flow rates, Q₁ and Q₂, by correlating the theoretical flow rates, Q₁ and Q₂, to experimentally measured flow rates. The second way involves the use of the adaptive gain factors, δ₁ and δ₂, which are multiplied to the error-correction factors, K₁ and K₂, respectively. These adaptive gain factors minimize errors between the estimated actuator position, X_{Est}, and the actual actuator position, X_{Act}. The third way in which errors associated with the theoretical calculations are minimized involves the use of two corrected flow rates, Q_{1,C} and Q_{2,C}, in the determination of the estimated actuator position, X_{Est}. By using two corrected flow rates, Q_{1,C} and Q_{2,C}, a discrepancy between the two corrected flow rates would be minimized by using some weighted mean function. This in turn would potentially reduce an error in the determination of the estimated actuator position.

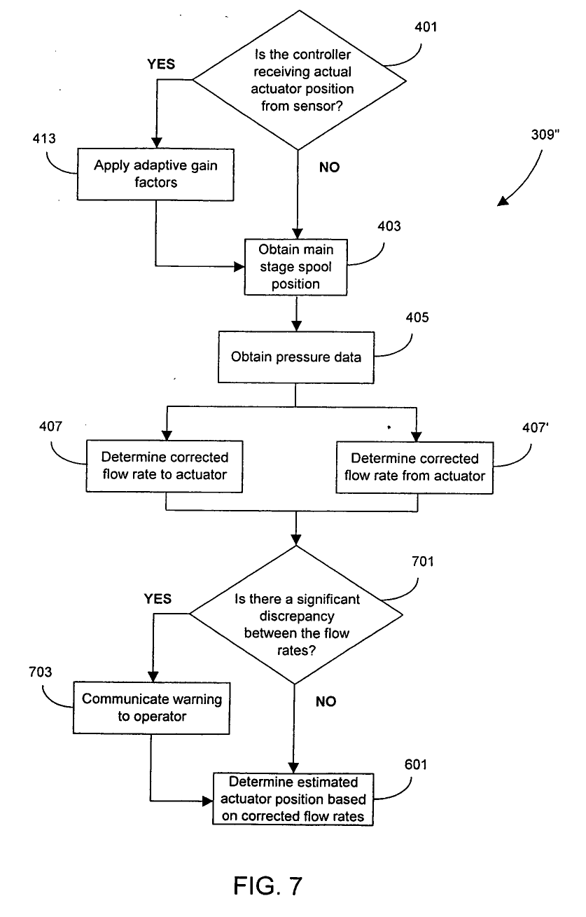

Referring now to FIG. 7, an alternate method 309″ is illustrated, which provides an additional advantage to using two corrected flow rates, Q_{1,C} and Q_{2,C}, in the determination of the estimated actuator position will be described. In the alternative method 309″, method steps that are the same or similar as those in methods 309 and 309′ will have the same reference number and will not be further described. Additional method steps, however, shall have reference numerals in excess of “700” and shall be described in detail.

In the alternate method 309″, a comparison is made between the two corrected flow rates, Q_{1,C} and Q_{2,C}, in step 701. If the corrected flow rates, Q_{1,C} and Q_{2,C}, are similar in value, the estimated actuator position is determine in step 601. If, however, the corrected flow rates, Q_{1,C} and Q_{2,C}, are significantly different, a warning is sent to the operator in step 703. In this way, the corrected flow rates, Q_{1,C} and Q_{2,C}, are used as a type of fault detection for the actuator position control system 11. For example, if the corrected flow rate, Q_{1,C}, for the first chamber 27 of the cylinder 21 is significantly different than the corrected flow rate, Q_{2,C}, for the second chamber 29 of the cylinder 21, a warning is communicated to the operator in step 703 that there may be a problem with the actuator position control system 11. The type of warning is not critical to the scope of the present invention and could include visual or audible warnings. While the significant discrepancy in the corrected flow rates, Q_{1,C} and Q_{2,C}, could not isolate the problem to a specific component, such as one of the pressure sensors 31a, 31b, 31c, 31d or one of the spool position sensors 33a, 33b, in the actuator position control system 11, it would notify the operator of a potential problem with the system as a whole. It will be understood by those skilled in the art after reviewing the disclosure of the present invention that placement order of step 701 is not critical to the scope of the present invention.

The invention has been described in great detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims.

What is claimed is:

1. An actuator position control system comprising
an actuator;
at least one actuator position sensor mounted to the actuator;
a flow control valve having at least one main stage spool, at least one spool position sensor that monitors the position of the main stage spool, a supply port, a tank port, a first control port, and a second control port wherein the flow control valve is in fluid communication with the actuator;
a plurality of fluid pressure sensors for monitoring pressure of fluid at the supply port, the tank port, the first control port, and the second control port of the flow control valve; and
a controller being in electrical communication with the flow control valve, wherein the controller is configured to:
receive a desired actuator position input;
receive fluid pressure data signals from the plurality of fluid pressure sensors;
receive spool position signals from the spool position sensor;
receive actuator position data signals from the actuator position sensor;
determine corrected fluid flow rates to and from the actuator based on the fluid pressure data signals, the spool position signals, and an error-correction factor, wherein the error-correction factor is a function of the fluid pressure data signals and the spool position signals;
determine estimated actuator position, wherein the estimated actuator position determination includes a kinematic component, which is a function of the corrected fluid flow rates to and from the actuator, and a dynamic component, which is a function of a pressure of a chamber of the actuator;
apply adaptive gain factors to calibrate the estimated actuator position to the actuator position data signals from the actuator position sensor;
compare the estimated actuator position to the desired actuator position input; and
close the main stage spool valve to prevent fluid communication to the actuator.

2. An actuator position control system as claimed in claim 1 wherein the controller is further configured to compare the corrected fluid flow rate to the actuator and the corrected fluid flow rate from the actuator and send a warning signal when there is a significant difference between the corrected fluid flow rates.

3. An actuator position control system as claimed in claim 2 wherein the warning signal is audible.

4. An actuator position control system as claimed in claim 2 wherein the warning signal is visual.

5. An actuator position control system as claimed in claim 1 wherein the actuator is a linear actuator.

6. An actuator position control system as claimed in claim 5 wherein the actuator is a cylinder.

7. An actuator position control system as claimed in claim 6 wherein the actuator position sensor is mounted at a center location on the cylinder.

8. An actuator position control system as claimed in claim 1 wherein the plurality of fluid pressure sensors are disposed in the flow control valve.

9. An actuator position control system as claimed in claim 1 wherein the controller is disposed in the flow control valve.

10. An actuator position control system as claimed in claim 1 wherein the flow control valve includes two main stage spools.

11. An actuator position control system as claimed in claim 10 wherein a pilot stage spool is associated with each main stage spool in the flow control valve.

12. An actuator position control system as claimed in claim 1 wherein the spool position sensor is a Linear Variable Differential Transformer.

13. An actuator position control system as claimed in claim 1 wherein the actuator position sensor is a latch sensor.

14. A method for estimating actuator position comprising the steps of
receiving fluid pressure data signals from a plurality of fluid pressure sensors;
receiving spool position signals from at least one spool position sensor;
receiving actuator position data signals from at least one actuator position sensor;
determining corrected fluid flow rates to and from an actuator with each corrected fluid flow rate based on the fluid pressure data signals, the spool position signals, and an error-correction factor, wherein the error-correction factor is a function of the fluid pressure data signals and the spool position signals;
determining an estimated actuator position, wherein the estimated actuator position determination includes a kinematic component, which is a function of the corrected fluid flow rates to and from the actuator, and a dynamic component, which is a function of a pressure of a chamber of the actuator; and
applying adaptive gain factors to calibrate the estimated actuator position to the actuator position data signals from the actuator position sensor.

15. A method for determining actuator position as claimed in claim 14 further comprising the step of comparing the corrected fluid flow rate to the actuator and the corrected fluid flow rate from the actuator.

16. A method for determining actuator position as claimed in claim 15 wherein a weighted function is applied to the corrected fluid flow rate to the actuator and the corrected fluid flow rate from the actuator in determining the estimated actuator position.

17. A method for determining actuator position as claimed in claim 15 wherein a warning signal is sent from a controller when there is a significant discrepancy between the corrected fluid flow rate to the actuator and the corrected fluid flow rate from the actuator.

18. A method for determining actuator position as claimed in claim 14 wherein the spool position sensor is a Linear Variable Differential Transformer.

19. A method for determining actuator position as claimed in claim 14 wherein the actuator displacement sensor is a latch sensor.

20. A method for determining actuator position as claimed in claim 14 wherein the actuator is a linear actuator.

21. A method for determining actuator position as claimed in claim 20 wherein the actuator is a cylinder.
